(19) United States
(12) Patent Application Publication
(10) Pub. No.: US 2026/0131318 A1
(43) Pub. Date: May 14, 2026

(54) ZEOLITE CATALYSTS WITH PAIRED HETEROATOMS AND METHODS THEREOF

(71) Applicants: BASF CORPORATION, Florham Park, NJ (US); THE REGENTS OF THE UNIVERSITY OF CALI FORNIA, Oakland, CA (US)

(72) Inventors: Michael Brandon SCHMITHORST, Santa Barbara, CA (US); Subramanian PRASAD, Iselin, NJ (US); Bradley F. CHMELKA, Oakland, CA (US); Ahmad MOINI, Iselin, NJ (US); Vivek VATTIPALLI, Iselin, NJ (US)

(21) Appl. No.: 18/706,861

(22) PCT Filed: Nov. 4, 2022
(86) PCT No.: PCT/US2022/079261

§ 371 Date: May 2, 2024

Related U.S. Application Data
(60) Provisional application No. 63/263,599, filed on Nov. 5, 2021.

(51) Int. Cl. B01J 29/76; B01D 53/94; B01J 35/57; B01J 37/02; B01J 37/08; F01N 3/20; F01N 3/28

(52) U.S. Cl. CPC B01J 29/763; B01D 53/9418; B01D 53/9477; B01J 35/57; B01J 37/0225; B01J 37/0236; B01J 37/08; F01N 3/2066; F01N 3/2803; B01D 2255/20761; B01D 2255/50; B01D 2255/9155; B01D 2257/404; B01D 2257/406; B01D 2258/012; F01N 2370/04

(57) ABSTRACT

The present disclosure relates to zeolite catalysts having an aging durability and improved catalytic activity. For example, the zeolite catalysts comprise a specific aluminum distribution, e.g., the positioning of two framework aluminum atoms in the zeolite structure at third-nearest-neighbor (3NN) relative positions in the framework. The zeolite catalysts have two tetrahedrally coordinated AI sites that are separated by two tetrahedrally coordinated Si sites. The disclosure is also directed to process and methods for their characterization and usage.

This application claims priority to U.S. Application No. 63/263,599, filed Nov. 5, 2021; the disclosure is incorporated herein by reference in its entirety.

The present disclosure relates to zeolite catalysts having an aging durability and improved catalytic activity. For example, the zeolite catalysts comprise a specific aluminum distribution, i.e., the positioning of two aluminum atoms in the zeolite structure at 3NN relative positions. The zeolite catalysts have two tetrahedral Al sites that are separated by two tetrahedral Si sites. The disclosure is also directed to process and methods for their characterization and usage.

Molecular sieves such as zeolites have been utilized in the selective catalytic reduction (SCR) of nitrogen oxides (NOx) with a reductant such as ammonia, urea or hydrocarbons. Zeolites are crystalline materials having rather uniform pore sizes which, depending upon the type of zeolite and the type and number of cations included in the zeolite lattice, range from about 3 to about 25 Angstroms in diameter. Zeolites having 8-ring pore openings and double-6-ring secondary building units, for example those having cage-like structures are of interest as SCR catalysts. The number of rings refers to the number of approximately tetrahedrally coordinated atoms in interconnected rings of the zeolite framework. Included in this category are zeolites having a chabazite (CHA) crystal structure, which are small pore zeolites with 8 member-ring pore openings (ca. 3.8 Angstroms) that are accessible through its 3-dimensional porosity. A cage like structure results from the connection of double-6-ring building units by 4-member rings. Chabazite (CHA) zeolite catalysts have garnered interest for selective catalytic reduction (SCR) of NOx. The amount of Al may have a role on the reaction properties and the stability of the zeolite framework, but currently there is no method that provides direct evidence for determining Al siting within the zeolite framework, and it is unclear what kind of role and to what extent the distribution of Al impacts the reaction properties.

Metal-promoted zeolite catalysts are also often referred to as ion-exchanged zeolites or zeolites supported with copper and/or iron including, among others, copper-promoted and iron-promoted zeolite catalysts, for the SCR of nitrogen oxides with ammonia are known and can typically be prepared via metal ion-exchange processes. However, it has been found that under harsh hydrothermal conditions, the activity of many metal-promoted zeolites begins to decline. This decline in activity is believed to be due to destabilization of the zeolite such as by dealumination or by the reduction of the metal-containing catalytic sites within the zeolite.

Catalysts used in the SCR process should ideally be able to retain high catalytic activity over the wide range of temperature conditions of use, for example from about 150° C. to about 600° C. or higher, under hydrothermal conditions. Hydrothermal conditions are encountered in practice because water is a byproduct of fuel combustion and high temperature hydrothermal conditions occur in diesel exhaust applications, such as during the regeneration of a soot filter, a component of exhaust gas treatment systems used for the removal of carbonaceous particles.

The SCR process converts nitrogen oxides (NOₓ) to nitrogen (N₂) and water (H₂O). It is desired that selective conversion of NOₓ occurs within internal combustion engine exhaust streams to N₂ while minimizing the formation of undesired N₂O. Undesired N₂O formation may be observed as molar percent conversion of (NO+NO₂) to N₂O. Nitrogen oxides (NOₓ) may include N₂O, NO, N₂O₃, NO₂, N₂O₄, N₂O₅ or NO₃.

Zeolites, such as aluminosilicate zeolites, are of considerable technological interest because their high surface areas, well-defined sub-nanometer pores, and cation exchange sites enable catalytic applications for hydrocarbon conversion or pollution reduction. The catalytic properties of zeolites arise from the non-stoichiometric substitution of AlO₄ tetrahedra for SiO₄ tetrahedra, respectively, which introduces negative framework charges that are balanced by exchangeable cations. In their solid-acid (H⁺) forms, aluminosilicate zeolites, such as faujasite (Y zeolites) and chabazite (CHA, zeolite SSZ-13), are highly active as heterogeneous catalysts for hydrocarbon rearrangement reactions including cracking or the conversion of methanol to light olefins. In their metal-exchanged forms, aluminosilicate zeolites are of interest as catalysts that reduce NOₓ emissions in automobile exhaust streams by converting NOₓ compounds to N₂ and H₂O in the presence of a sacrificial reductant. Examples of metal-exchanged forms for this application include copper and iron. Different copper-exchanged zeolites exhibit very different reactivities, about which little is known at an atomic level. Among the reasons for such differences are the distinct local compositions and atomic environments of framework heteroatoms, such as aluminum, that directly influence the distributions of exchangeable cations that are often catalytically important sites. Measuring and understanding the influences of framework heteroatom environments on catalytic activity and selectivity has been challenging, in part due to the disordered distributions of heteroatoms within zeolite frameworks which preclude detailed analysis by conventional scattering or spectroscopic techniques. By comparison, solid-state nuclear magnetic resonance (NMR) spectroscopy measurements are sensitive to the local chemical environments of NMR-active species (e.g., ¹H, ²⁷Al, and ²⁹Si) in aluminosilicate zeolites. Solid-state NMR spectroscopy can be used to identify different kinds of ²⁷Al and ²⁹Si species and establish their relative quantities and proximities, including to exchangeable copper cations.

There is a desire to prepare improved zeolite catalysts having higher hydrothermal stabilities, for example, to convert methanol or propanol to olefins. Additionally, there is a desire to prepare improved zeolite catalysts having higher catalytic activity and selectivity. The present disclosure provides for zeolite catalysts having an aging durability and improved catalytic activity. For example, the zeolite catalysts comprise a specific aluminum distribution, i.e., the positioning of two tetrahedrally coordinated aluminum atoms at sites in the zeolite structure that are separated by two Si tetrahedral sites and in third-nearest-neighbor (3NN) relative positions. The disclosure is also directed to process and methods for their characterization and usage.

The present disclosure generally provides a zeolite catalyst with paired framework aluminum atoms, wherein the paired aluminum atoms are third-nearest neighbors (3NN) in a zeolite structure and wherein the zeolite catalyst has an aging durability, an improved catalytic activity, or a combination thereof.

In some embodiments, the zeolite catalyst is a CHA zeolite catalyst.

In some embodiments, the zeolite catalyst is a CHA zeolite catalyst, wherein the CHA zeolite catalyst is a copper-CHA catalyst.

In some embodiments, the zeolite of the zeolite catalyst composition is a small pore zeolite.

In some embodiments, the small pore zeolite of the zeolite catalyst composition is AE zeolite framework type.

In some embodiments, the small pore zeolite of the zeolite catalyst composition is AFX zeolite framework type.

In some embodiments, the small pore zeolite of the zeolite catalyst composition is AFT zeolite framework type.

In some embodiments, the zeolite catalyst has a ²⁹Si NMR signature that exhibits ²⁹Si signals that ranges from −104 ppm (i.e., Hz/10⁶ Hz) to −108 ppm in the single quantum (SQ) dimension and −208 to −212 ppm in the double quantum (DQ) dimension when measured using 2D ²⁹Si—²⁹Si J-mediated NMR.

In some embodiments, the zeolite catalyst has a ²⁹Si NMR signature ranging from −98 ppm to −100 ppm in the ²⁹Si dimension and 55 to 60 ppm in the ²⁷Al dimension when measured using solid-state 2D ²⁷Al{²⁹Si} J-mediated heteronuclear multiple-quantum correlation (HMQC) NMR.

In some embodiments, wherein the zeolite catalyst exhibits an aging durability after 800° C. hydrothermal aging, wherein the zeolite catalyst exhibits 10% higher NOₓ conversion relative to a zeolite that does not contain the 3NN sites.

In some embodiments, wherein the zeolite catalyst exhibits an age durability after 850° C. hydrothermal aging, wherein the zeolite catalyst exhibits at least 50% NOₓ conversion.

In some embodiments, wherein the zeolite catalyst exhibits improved catalytic activity of the zeolite catalyst for methanol dimerization, with approximately 10% higher conversion relative to a zeolite that does not contain the 3NN sites.

In some embodiments, the zeolite catalyst has a SiO₂/Al₂O₃ ratio (SAR) chosen from 8-40, 10-30, or 11-25.

In some embodiments, the zeolite catalyst further comprises copper (Cu) with a Cu content corresponding to a Cu/Al ratio chosen from of 0.2 to 0.5, 0.25 to 0.45, or 0.3 to 0.4.

In some embodiments, a catalyst article effective to abate nitrogen oxides (NOₓ) from a lean burn engine exhaust gas, the catalyst article comprising a substrate carrier having a selective catalytic reduction (SCR) catalyst comprising the zeolite catalyst.

In some embodiments, the SCR catalyst, wherein the substrate carrier is a honeycomb substrate, and optionally constructed of metal or ceramic.

In some embodiments, the SCR catalyst, wherein the honeycomb substrate carrier is a flow-through substrate or a wall flow filter.

In some embodiments, an exhaust gas treatment system comprises: a lean burn engine that produces an exhaust stream; and an SCR catalyst positioned downstream from the lean burn engine and in fluid communication with the exhaust gas stream.

In some embodiments, the exhaust gas treatment system further comprises one or more of the following:
a diesel oxidation catalyst (DOC) positioned upstream of the SCR catalyst article; a soot filter positioned upstream of the catalyst article; and an ammonia oxidation catalyst (AMOX) positioned downstream of the catalyst article.

In some embodiments, a process for preparing a diesel oxidation catalyst (DOC) comprises:
preparing the zeolite catalyst composition; applying the catalyst as a coating onto a ceramic or a metallic honeycomb substrate monolith substrate; drying the coated monolith; calcining the coated monolith at a temperature ranging from 400° C. to 800° C.

These and other features, aspects, and advantages of the disclosure will be apparent from a reading of the following detailed description together with the accompanying drawings, which are briefly described below. Other aspects and advantages of the disclosed subject matter will become apparent from the following.

### BRIEF DESCRIPTION OF DRAWING(S)

To provide an understanding of embodiments of the disclosure, reference is made to the appended drawings, in which reference numerals refer to components of exemplary embodiments of the disclosed subject matter. The drawings are exemplary only and should not be construed as limiting the disclosure. The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1(A) is representative spectra of 1 D direct-excitation in situ ¹³C MAS NMR of methanol reacting to form dimethyl ether over the dehydrated H⁺-form of Sample A and Sample B in a sealed NMR rotor at 150° C.

FIG. 1(B) is the methanol conversion over time for Sample A and Sample B at 125° C. and 150° C. is tracked by direct-excitation ¹³C NMR, as shown in FIG. 1(A).

FIG. 1(C) is the NOₓ conversion data for Samples C, D, and G.

FIG. 1(D) is the N₂O selectivity data for Samples C, D, and G.

FIG. 1(E) is the NOₓ conversion data for Samples A and B.

FIG. 2(A) is a 1 D direct-excitation ²⁹Si MAS NMR spectra.

FIG. 2(B) is a 1 D direct-excitation ²⁷Al MAS NMR spectra of the hydrated H⁺-form of samples A and B.

FIG. 3 (A) is a 2D ²⁹Si{²⁹Si} J-mediated single-quantum-double quantum (SQ-DQ) NMR spectrum of the hydrated H⁺-form of Sample A.

FIG. 3 (B) is a 2D ²⁹Si{²⁹Si} J-mediated SQ-DQ NMR spectrum of the hydrated H⁺-form of Sample B.

FIG. 4(A) is a 2D²⁷Al{²⁹Si} J-mediated HQMC NMR spectrum of the hydrated H⁺-form of Sample A and a 1 D ²⁹Si{¹H} cross-polarization magic-angle-spinning (CP-MAS) spectra acquired under identical conditions for Sample A is shown along the vertical axis of each 2D spectrum.

FIG. 4(B) is a 2D²⁷Al{²⁹Si} J-mediated HQMC NMR spectrum of the hydrated H⁺-form of Sample B and a 1 D ²⁹Si{¹H}CP-MAS spectra acquired under identical conditions for Sample B is shown along the vertical axis of each 2D spectrum.

FIG. 5 is a diagram of catalytic sites in aluminosilicate chabazite (SSZ-13).

FIG. 6 shows the structure of “paired” Al framework for Cu²⁺ containing catalysts.

FIG. 7(A) illustrates the ²⁹Si—O—²⁹Si connectivity differences revealed by 2D NMR.

FIG. 7(B) is a schematic illustrating the ²⁹Si—O—²⁹Si connectivity differences corresponding to the 2D NMR spectrum shown in FIG. 7(A).

FIG. 8 is a 2D ²⁹Si{²⁹Si} J-mediated solid-state NMR spectrum of the hydrated H⁺-form of Sample C. The spectrum was acquired at 9.4 T, 8 kHz MAS, and 100 K.

FIG. 9(A) is a 2D ²⁹Si{²⁹Si} dipolar-mediated solid-state NMR spectra of the hydrated H⁺-form of Sample C. The spectrum was acquired at 9.4 T, 8 kHz MAS, and 100 K.

FIG. 9(B) is a 2D ²⁹Si{²⁹Si} dipolar-mediated solid-state NMR spectra of the hydrated H⁺-form of Sample D. The spectrum was acquired at 9.4 T, 8 kHz MAS, and 100 K.

FIG. 10 is a 2D ²⁹Si{²⁹Si} J-mediated solid-state NMR spectrum of the hydrated H⁺-form of sample D. The spectrum was acquired at 9.4 T, 8 kHz MAS, and 100 K.

FIG. 11 is a 2D ²⁹Si{²⁹Si} J-mediated solid-state NMR spectrum of the hydrated H⁺-form of sample G. The spectrum was acquired at 9.4 T, 8 kHz MAS, and 100 K.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein “a molar percentage of [X] calculated based on a total number of moles of [X] and [Y],” e.g., in the context of a nanoparticle refers to a percentage calculated as:

$$\frac{moles of [ X ]}{( moles of [ X ] ) + ( moles of [ Y ] )} \times 100 \%$$

As used herein, the term “associated” means, i.e., “equipped with,” “connected to,” or in “communication with,” e.g., “electrically connected” or in “fluid communication with” or otherwise connected in a way to perform a function. As used herein, the term “associated” may mean directly associated with or indirectly associated with, i.e., through one or more other articles or elements.

As used herein, the term “AEI” refers to an AEI type framework as recognized by the International Zeolite Association (IZA) Structure Commission and the term “AEI zeolite” means an aluminosilicate in which the primary crystalline phase is AEI.

As used herein, the term “AFX” refers to an AFX type framework as recognized by the International Zeolite Association (IZA) Structure Commission and the term “AFX zeolite” means a silico-aluminophosphate-fifty-six.

As used herein, the term “AFT” refers to an AFT type framework as recognized by the International Zeolite Association (IZA) Structure Commission and the term “AFT zeolite” means an AlPO₄-52 catalyst.

As used herein, the term “BET surface area” has its usual meaning of referring to the Brunauer, Emmett, Teller method for determining the surface area of a porous material by N₂ adsorption. Pore diameter and pore volume can also be determined using BET-type N₂ adsorption or desorption experiments.

As used herein, the term “catalyst” or “catalyst material” or “catalytic material” refers to a material that promotes a reaction.

As used herein, the term “catalytic article” refers to an element that is used to promote a desired reaction. For example, a catalytic article may comprise a washcoat containing a catalytic species, e.g., a catalyst composition, on a substrate, e.g., a honeycomb substrate.

As used herein, the term “average particle size” refers to a characteristic of particles that indicates, on average, the diameter of the particles.

As used herein, the term “material” refers to an element, constituent, or substance of which something is composed or can be made.

As used herein, the term “nanoparticle” refers to a particle having at least one dimension that is the range of 1 nm to 999 nm in length.

As used herein, the terms “nitrogen oxides” or NOₓ” designate the oxides of nitrogen.

As used herein, the term “particle size” refers to the smallest diameter sphere that will completely enclose the particle, and this measurement relates to an individual particle as opposed to an agglomeration of two or more particles. Particle size may be measured by laser light scattering techniques, with dispersions or dry powders, e.g., according to ASTM method D4464. Particle size may also be measured by Scanning Electron Microscopy (SEM) or Transmission Electron Microscopy (TEM) for submicron size particles, or by a particle size analyzer for support-containing particles (micron size). In addition to TEM, carbon monoxide (CO) chemisorption may be used to determine average PGM particle size. This technique does not differentiate between various PGM species (e.g., Pt, Pd, etc., as compared to XRD, TEM, and SEM) and only determines the average particle size. As used herein, the term “room temperature” or “ambient temperature” refers to a temperature in the range of 15° C. to 25° C., such as, e.g., 20° C. to 25° C.

As used herein, the term “substantially” refers to a property having a statistical occurrence greater that 75%.

As used herein, “support” in a catalytic material or catalyst washcoat refers to a material that receives a catalyst (including, for example, precious metals, stabilizers, promoters, binders, and the like) through precipitation, association, dispersion, impregnation, or other suitable methods.

As used herein, the term “selective catalytic reduction” (SCR) refers to the catalytic process of reducing oxides of nitrogen to dinitrogen (N₂) using a nitrogenous reductant. The SCR process uses catalytic reduction of nitrogen oxides with ammonia to form nitrogen and water.

As used herein, the term “washcoat” has its usual meaning in the art of a thin, adherent coating of a catalytic or other material applied to a carrier substrate material, such as a honeycomb-type carrier member, which is sufficiently porous to permit the passage of the gas stream being treated. As is understood in the art, a washcoat is obtained from a dispersion of particles in slurry, which is applied to a substrate, dried, and calcined to provide the porous washcoat.

As used herein, the term “zeolite” refers to a specific example of a molecular sieve, including silicon and aluminum atoms. Zeolites are crystalline materials having rather uniform pore sizes which, depending upon the type of zeolite and the type and the amount of cations included in the zeolite lattice, range from about 3 to 10 Angstroms (Å) in diameter.

In more specific embodiments, reference to an “aluminosilicate zeolite” framework type limits the material to molecular sieves that do not include phosphorous or other metals substituted in the framework. However, to be clear, as used herein, “aluminosilicate zeolite” excludes aluminophosphate materials such as SAPO, ALPO, and MeAPO materials, and the broader term “zeolite” is intended to included aluminosilicates and aluminophosphates.

Zeolitic CHA-framework type molecular sieves, otherwise referred to herein as “CHA zeolites.”.

As used herein, the term “promoted” refers to a metal component (“promoter metal”) that is intentionally added to the molecular sieve material, as opposed to impurities inherent in the molecular sieve. Thus, a promoter is intentionally added to enhance activity of a catalyst compared to a catalyst that does not have promoter intentionally added. In order to promote the selective catalytic reduction of nitrogen oxides in the presence of ammonia, in one or more embodiments, a suitable metal(s) is independently exchanged into the molecular sieve. In some embodiments, further promoter metals that can be used to prepare promoted zeolites of the disclosed catalyst compositions include, but are not limited to, copper (Cu). The promoter metal content, calculated as the oxide, in one or more embodiments, independently ranges from about 0.01 wt. % to about 15 wt. %, from about 0.5 wt. % to about 12 wt. %, or from about 1.0 wt. % to about 10 wt. %, based on the total weight of the corresponding calcined zeolite (including the promoter metal) and reported on a volatile-free basis. In some embodiments, the promoter metal is copper or iron. In some embodiments, both copper and iron are present as promoter metals.

### Zeolite Catalysts

The present disclosure relates to zeolite catalysts having an aging durability and improved catalytic activity. For example, the zeolite catalysts comprise a specific aluminum distribution, i.e., the positioning of two aluminum atoms in the zeolite structure at 3NN relative positions. The zeolite catalysts have two tetrahedrally coordinated Al sites that are separated by two tetrahedrally coordinated Si sites within the zeolite framework.

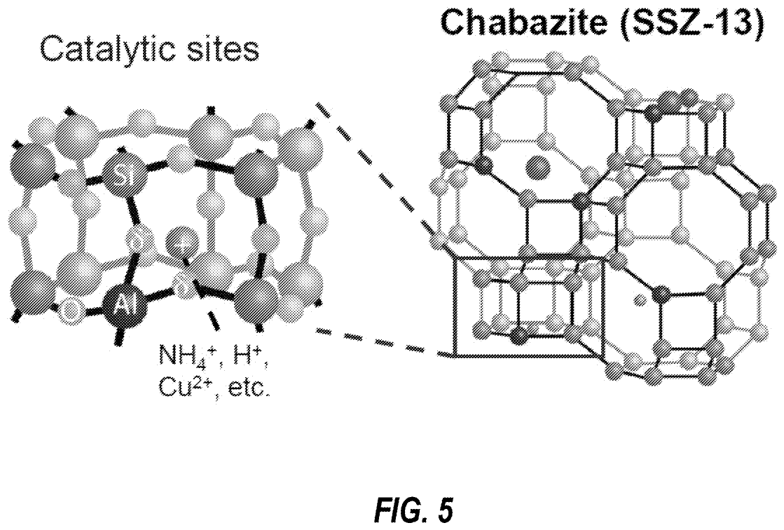

The locations and proximities of exchangeable cations, such as H⁺, Cu²⁺, Zn²⁺, are dependent on the location of Al heteroatoms in the zeolite framework. For example, paired Al heteroatoms located near each other as second- or third-nearest neighbors in the aluminosilicate framework help to stabilize divalent exchangeable cations. This stabilization creates improved chemical reaction properties. That is, the Al content and specifically the distribution of paired Al sites in the zeolite framework influence the rate of conversion of methanol to olefins and the resultant product selectivity over an aluminosilicate zeolite H⁺/Cu²⁺-SSZ-13 catalyst. This is shown in FIG. 5, a diagram of catalytic sites in aluminosilicate chabazite (SSZ-13).

In another example, SCR of NOₓ pollutant species in vehicle exhaust streams to N₂ and other products rely on paired Al sites for the exchange of Cu²⁺.

SAPO-34 and SSZ-13 are two catalysts with the CHA structure that have been commonly studied for the methanol-to-olefin (MTO) reaction. SAPO-34 has been commercialized for use in MTO reactions and SSZ-13 is the zeolite analogue of SAPO-34 and can exhibit selectivity for ethylene and propylene. While SSZ-13 is the zeolite analogue of SAPO-34, it exhibits different reaction behavior than SAPO-34, and the difference in reaction behavior is attributed to the Brønsted acid sites. In both SSZ-13 and SAPO-34, Brønsted acid sites catalyze the MTO reaction. Stronger Brønsted acid sites are present in SSZ-13, which leads to increased coking and deactivation. The deactivation and product selectivity for both CHA-type catalyst is attributed to acid site density. Increasing the Si/Al ratio in SSZ-13 samples may increase catalyst stability and reaction time before deactivation.

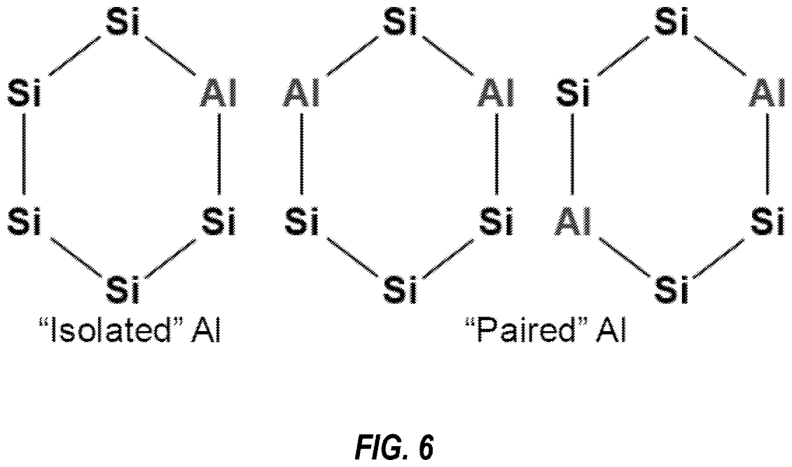

Understanding and controlling the population and distribution of Al heteroatoms and the associated cations to increase the number of paired framework Al sites improve the catalytic properties of a zeolite catalyst. An example of the structure of “paired” Al framework for Cu²⁺ containing catalysts is shown in FIG. 6. Traditional methods of determining the population and distribution of Al heteroatoms include elemental analysis, 1D solid-state NMR. However, 1D solid-state NMR provides limited insight regarding Al siting since the signals overlap, leading to difficulty in defining connectivity between different sites.

The present disclosure relates to zeolite catalysts having an aging durability and improved catalytic activity. For example, the zeolite catalysts comprise a specific aluminum distribution, i.e., the positioning of two aluminum atoms in the zeolite structure at 3NN relative positions. The zeolite catalysts have two tetrahedral Al sites that are separated by two tetrahedra Si sites.

The present disclosure is directed to, e.g., paired Al atoms which are separated as second- or third-nearest tetrahedral-site neighbors in the SSZ-13 zeolite framework, which lead to improved catalytic properties. The present disclosure enables the design of catalysts with targeted reaction properties, e.g., for reactions, including adsorption processes, where divalent or trivalent cations have a significant influence.

In some embodiments, the present disclosure is directed to a zeolite catalyst with paired aluminum atoms, wherein the paired aluminum atoms are separated as second- or third-neighbors in a zeolite structure. For example, in identifying different kinds of ²⁷Al and ²⁹Si species, of interest are zeolite catalysts with paired aluminum atoms, primarily where the aluminum atoms are third-nearest neighbors (3NN). In a 3NN distribution, the two tetrahedral Al sites are separated by two tetrahedral Si sites.

In some embodiments, the zeolite catalysts of the present disclosure have 8-member-ring pore openings and double-6-ring secondary building units, particularly those having cage-like structures, are suited for use as SCR catalysts. In some embodiments, the zeolite catalyst of the present disclosure is chabazite (CHA), which is a small pore zeolite with 8 member-ring pore openings (about 3.8 Angstroms) accessible through its 3-dimensional porosity. A cage-like structure results from the connection of double-6-ring building units by 4-member rings.

In some embodiments, the present disclosure is directed to aluminosilicate zeolites, aluminosilicate zeolites having double-6-ring (D6R) building units, small pore (8-member-ring pore opening) aluminosilicate zeolites, small pore (8-member-ring pore opening) aluminosilicate zeolites having double-6-ring (D6R) building units, and chabazite zeolites. In some embodiments, zeolite catalysts with the 3NN distribution of Al atoms may also contain metals such as copper, which may be introduced after the zeolite synthesis itself. In some embodiments, the Cu metal is also introduced during the synthesis of the zeolite.

In some embodiments, the present disclosure is directed to a catalyst composition comprising an aluminosilicate catalyst with paired aluminum atoms, wherein the paired aluminum atoms are separated as second- or third-neighbors in an aluminosilicate structure.

In some embodiments, the zeolite catalysts of the present disclosure comprise a SiO₂/Al₂O₃ (SAR) ratio ranging from 8-40. In some embodiments, the zeolite catalysts of the present disclosure comprise a SiO₂/Al₂O₃ (SAR) ratio ranging from such as from 10-30. In some embodiments, the zeolite catalysts of the present disclosure comprise a SiO₂/Al₂O₃ (SAR) ratio ranging from 11-25.

In some embodiments, the zeolite catalysts of the present disclosure comprise a Cu content corresponding to Cu/Al ratio from about 0.2 to about 0.5. In some embodiments, the zeolite catalysts of the present disclosure comprise a Cu content corresponding to Cu/Al ratio from about 0.25 to about 0.45. In some embodiments, the zeolite catalysts of the present disclosure comprise a Cu content corresponding to Cu/Al ratio from about 0.3 to about 0.4

Catalysts of the present disclosure can be adapted to a wide range of heteroatom-containing silicate materials, such as nanoporous alumino-, boro-, or gallo-silicates with applications in catalysis or separations.

The zeolites with the 3NN aluminum distribution, after introduction of metals such as Cu, exhibit improved NOₓ conversion under selective catalytic reduction (SCR) conditions. For example, in some embodiments, the zeolite catalysts of the present disclosure have an aging durability and a high or improved catalytic activity of compared to a zeolite without the 3NN aluminum distribution.

In some embodiments, the zeolite catalysts of the present disclosure after 800° C. hydrothermal aging exhibit 10% higher NOₓ conversion (800° C. for 16 hours in the presence of 10 vol. % steam and balance air, the exhaust gas having an hourly volume-based space velocity of 80,000 h⁻¹ under pseudo-steady-state conditions and comprising a gas mixture of 500 ppm NO 500 ppm NH₃, 10% O2, 5% H₂O, balance N₂). In some embodiments, the zeolite catalysts of the present disclosure after 850° C. (16 h) hydrothermal aging provide a minimum of 50% NOₓ conversion (same conditions as above).

In some embodiments, the zeolite catalysts of the present disclosure with the 3NN aluminum distribution exhibit improved catalytic performance for methanol dimerization, with approximately 10% higher conversion relative to a zeolite that does not contain the 3NN sites in a batch reaction of 20 μL ¹³CH₃OH over 50 mg of dehydrated catalyst at 125° C. or 150° C. in an inert atmosphere of argon at ambient pressure. The conversion of methanol to dimethyl ether was tracked by in situ ¹³C NMR.

### Zeolite Synthesis

The present disclosure relates to zeolite catalysts having an aging durability and improved catalytic activity. For example, the zeolite catalysts comprise a specific aluminum distribution, i.e., the positioning of two aluminum atoms in the zeolite structure at 3NN relative positions. The zeolite catalysts have two tetrahedral Al sites that are separated by two tetrahedra Si sites. The disclosure is also directed to process and methods for characterizing and using those zeolite catalysts.

In some embodiments, the zeolite catalysts of the present disclosure are prepared by a range of synthesis approaches. In some embodiments, the source of aluminum is a precursor zeolite, such as one with the faujasite (FAU) structure. In some embodiments, the FAU source comprises Na—Y or various dealuminated forms of zeolite Y. In some embodiments, other zeolite precursors may also be used. In some embodiments, the source of aluminum may be an aluminum salt or complex such as aluminum isopropoxide, aluminum sulfate and related compounds.

In some embodiments, the present disclosure is further directed to methods for forming the zeolite catalysts. For example, a method comprises forming a reaction mixture comprising at least one alumina source that includes a zeolite (typically a zeolite having an FAU framework), at least one silica source (such as a source that includes an alkali metal silicate solution and/or colloidal silica), at least one organic structure-directing agent, and, optionally, a secondary alkali metal cation source to boost alkali metal content of the reaction mixture. The reaction mixture is typically provided under alkaline aqueous conditions. In certain embodiments, the combined molar ratio of alkali metal to Si (M/Si, where M is moles of alkali metal) and molar ratio of organic structure directing agent to Si (R/Si, where R is moles of organic structure-directing agent) is greater than the molar ratio of hydroxide ions to Si (OH/Si). In other words, the combined molar ratio of M/Si+R/Si is greater than the molar ratio OH/Si. For the bulk reaction mixture, the SAR range is typically about 25 to about 35.

In some embodiments, the combined M/Si+R/Si ratio is greater than about 0.75, or greater than about 0.80, or greater than about 0.82 or greater than about 0.85, with example ranges of about 0.75 to about 0.95, or about 0.80 to about 0.95, or about 0.85 to about 0.95.

In some embodiments, the OH/Si molar ratio is less than about 0.7, or less than about 0.65, or less than about 0.6, or less than about 0.55, with example ranges of about 0.3 to about 0.7 or about 0.4 to about 0.65.

In some embodiments, the individual M/Si molar ratio is at least about 0.4, or at least about 0.5, or at least about 0.6, or at least about 0.7, or at least about 0.8, with example ranges of about 0.4 to about 1.2, or about 0.6 to about 1.0, or about 0.7 to about 0.9. The alkali metal can be, for example, lithium, sodium, potassium, rubidium, cesium, or francium. In certain embodiments, the alkali metal is sodium or potassium.

In some embodiments, the individual R/Si molar ratio is less than about 0.12, or less than about 0.11, or less than about 0.10, or less than about 0.08, or less than about 0.06, with example ranges of about 0.04 to about 0.12, or about 0.06 to about 0.10.

The reaction mixture can also be characterized by the molar ratio of water to Si (H₂O/Si), which is typically in the range of about 12 to about 40.

The alkali metal silicate solution used in the reaction mixture can provide all of the alkali metal content needed to achieve the ratios noted above. However, alkali metal content of the reaction mixture is optionally supplemented with a secondary alkali metal cation source, with examples including alkali metal sulfate (e.g., Na₂SO₄), alkali metal acetate (e.g., sodium acetate), and alkali metal bromide (e.g., sodium bromide). If desired, in certain embodiments, the alkali metal silicate solution can be supplemented or replaced with other silica sources, such as colloidal silica, fumed silica, tetraethyl orthosilicate (TEOS), and combinations thereof.

The zeolite used as the alumina source can vary, and will include various zeolite materials known in the art, particularly various aluminosilicate zeolites. In certain embodiments, zeolites having the FAU crystalline structure are used, which are formed by 12-ring structures and have channels of about 7.4 Å Examples of such zeolites include faujasite, zeolite X, zeolite Y, LZ-210, and SAPO-37. Such zeolites are characterized by a 3-dimensional pore structure with pores running perpendicular to each other in the x, y, and z planes, with secondary building units 4, 6, and 6-6. An example SAR range for the bulk FAU zeolite material is about 3 to about 6, typically with a unit cell size range of 24.35 to 24.65, as determined by XRD. Zeolite Y is particularly useful for certain embodiments of the invention. The FAU zeolite is typically used in alkali metal form, such as the Na⁺ form. In some embodiments, the FAU zeolite is in the sodium form and comprises from about 2.5% to 13% Na₂O by weight.

A typical organic structure directing agent for this synthesis is adamantyl trimethylammonium hydroxide, although other amines and/or quaternary ammonium salts may be substituted or added. Examples include quaternary ammonium cations with substituents selected from the group consisting of alkyl, adamantyl, cyclohexyl, aromatic, and combinations thereof. Additional examples of organic structure directing agents include cyclohexyl trimethylammonium, benzyl trimethylammonium, and dimethylpiperidinium hydroxide.

Hydroxide ions are the only necessary mineralizing agent needed in the reaction mixture, and the amount of hydroxide needed to achieve the ratios noted above can be provided solely from the alkali metal silicate solution, and to a lesser extent, from the organic structure directing agent source. If desired, hydroxide ion content can be supplemented with additional hydroxide ion sources such as NaOH or KOH.

The reaction mixture can be characterized in terms of solids content, expressed as a weight percentage of silica (SiO₂) and alumina (Al₂O₃). The solids content can vary, with an example range being about 5 to about 25%, or about 8 to about 20%.

The reaction mixture is heated in a pressure vessel with stirring to yield the desired CHA crystalline product. Typical reaction temperatures are in the range of from about 100° C. to about 180° C., for instance from about 120° C. to about 160° C., with corresponding autogenous pressure. Typical reaction times are between about 30 hours to about 3 days. Optionally, the product may be centrifuged. Organic additives may be used to help with the handling and isolation of the solid product. Spray-drying is an optional step in the processing of the product.

In some embodiments, a zeolite with the MOR crystalline framework is formed as an intermediate product or as a side product. The MOR phase may contain an organic template.

The solid zeolite product is thermally treated or calcined in air or nitrogen. Typical calcination temperatures are from about 400° C. to about 850° C. (e.g., about 500° C. to about 700° C.) over a period of 1 to 10 hours. Following initial calcination, the CHA zeolite product is primarily in the alkali metal form (e.g., Na⁺ form). Optionally, single or multiple ammonia ion exchanges can be used to yield the NH₄⁺ form of the zeolite, which is optionally further calcined to form the H⁺ form.

In some embodiments, the CHA zeolite is further ion-exchanged with a promoter metal to form a metal-promoted zeolite catalyst. For example, copper or iron can be ion-exchanged to form Cu-CHA or Fe-CHA. When copper acetate is used, the copper concentration of the liquid copper solution used in the copper ion-exchange is, in some embodiments, in the range from about 0.01 to about 0.4 molar, and further for example, in the range from about 0.05 to about 0.3 molar.

In some embodiments, the CHA zeolite crystals resulting from the crystallization may be about 80% to about 99% crystalline or about 90% to about 97% crystalline.

In some embodiments, the CHA zeolite product may be characterized by a relatively low mesopore surface area (MSA) combined with a zeolite surface area (ZSA) that provides good catalytic performance. In some embodiments, the MSA of the CHA zeolite product is less than about 25 m²/g or less than about 10 m²/g (e.g., about 5 to about 25 m²/g). The ZSA of the CHA zeolite product is typically at least about 400 m²/g, or at least about 450 m²/g, or at least about 500 m²/g, with an example ZSA range of about 400 to about 600 m²/g or about 450 to about 600 m²/g. Pore volume and surface area characteristics can be determined by nitrogen adsorption (BET surface area method). Mesopore and zeolitic (micropore) surface areas were determined via N₂-adsorption porosimetry on a Micromeritics TriStar 3000 series instrument, in accordance with ISO 9277 methods. The samples were degassed for a total of 6 hours (a 2 hour ramp up to 300° C. then held at 300. ° C. for 4 hours, under a flow of dry nitrogen) on a Micromeritics SmartPrep degasser. Nitrogen BET surface area is determined using 5 partial pressure points between 0.08 and 0.20. Zeolitic and matrix surface areas are determined using the same 5 partial pressure points and calculated using Harkins and Jura t-plot. Pores having diameter greater than 20 Å are considered to contribute to matrix surface area.

The CHA zeolite product can also be characterized by a relatively low normalized ZSA loss after treatment with an NH₄F solution, such as less than about 60% (or less than about 50%) after treatment of the H⁺ form of the zeolite material with a 40 wt. % NH₄F solution at 50° C. with 350 rpm stirring and sonication (35 kHz, 90 W) for 20 minutes followed by drying and calcination at 450° C. for 6 hours. The formula for calculating normalized ZSA loss is presented in in U.S. Pat. No. 11,267,717.

In some embodiments, the CHA zeolite product typically may exhibit relatively few surface silanols as compared to bridging silanols (Brønsted sites), as estimated by comparing the integrated intensities of the peaks centered at 3742 cm⁻¹ (Peak X) to those at 3609 cm⁻¹ (Peak Y) using diffuse reflectance infrared Fourier transform (DRIFT) spectroscopy. DRIFTS measurements were taken on Thermo Nicolet with a Mercury-Cadmium-Telluride (MCT) detector and a Harrick environmental chamber with ZnSe windows. The samples were ground into a fine powder with a mortar and pestle, and then filled into the sample cup. The sample powder was first dehydrated at 400° C. for 1 h in flowing Ar at the flow rate of 40 ml/min and then cooled down to 30° C. A spectrum was taken for the sample and KBr is used as reference. In certain embodiments, the surface silanol fraction (X/Y peak ratio) of the CHA zeolite product is less than about 0.04 or less than about 0.03.

The CHA zeolite product resulting from the method typically has an average crystal size of up to about 3 μm, or ranging from about 200 nm to about 3 μm, or from about 500 nm to about 2 μm, or from about 800 nm to about 1.5 μm. Average crystal sizes can be measured, for example, using microscopy, e.g., scanning electron microscopy (SEM).

The CHA zeolite product can also be characterized by the amount of extra-framework aluminum in the H⁺ form (EFAI), determined as the percentage of total aluminum detected by ²⁷Al NMR. The H⁺ form of the zeolite is obtained by ammonium exchange of the Na⁺ form with NH₄NO₃, followed by a calcination at 450° (6 h). In certain embodiments, the CHA zeolite product has EFAI of less than about 20% or less than about 18%, such as about 5% to about 18% (or about 5% to about 15%). Percentage of extra-framework aluminum (EFAI) is defined as the integrated peak intensities in the frequency range of 20 to −30 ppm in the NMR spectra measured at 14.1 T.

Determining a Zeolite Catalyst with Third-Nearest Neighbors (3NN) Paired Aluminum Atoms

A method of characterizing covalent bond connectivities between J-coupled heteroatoms in a zeolite material comprising: synthesizing a zeolite material, where trimethyladamantylammonium hydroxide (TMAdaOH) is used as the organic structure directing agent (OSDA) for the zeolite material. Crystallization of the zeolite can be performed using a mineralizing agent an Na+source, an Al source, and/or an Si source. The mineralizing agent can be sodium hydroxide (NaOH). The Na+source may be chosen from NaOH, and/or Na₂SO₄. The Al source may be chosen from Na-FAU and/or aluminum isopropoxide. The Si source may be chosen from colloidal silica, and/or sodium silicate solution. The zeolite material products are then isolated via filtration, dried and calcined at 540° C. for 6 h to yield the Na+ form. The zeolite materials are characterized via XRD and N₂-Physisorption. After calcination is performed, single or multiple NH₄⁺ exchanges are performed until the Na₂O content reaches <500 ppm. The NH₄⁺ form of the zeolite material then undergoes calcination at 450° C. for 6 h, to yield the H⁺ form, which is then analyzed by solid-state NMR.

The distribution of Al species within the zeolite framework, including paired 2NN and 3NN Al species, can be assessed by 2D²⁷Al{²⁹Si} J-HMQC NMR and 2D ²⁹Si{²⁹Si} J-mediated SQ-DQ NMR spectra, respectively, both types of which were acquired at 9.4 T, 8 kHz MAS and 100 K.

Correlating the NMR spectra to aluminum (Al) sites of the zeolite material is performed by analyzing both the 1 D and 2D solid-state NMR spectra. From 1 D solid-state 1 D NMR of zeolites, it is known that ²⁹Si NMR spectrum exhibits ²⁹Si signals in the Q⁴ region at −105 ppm, −110 ppm, −113 ppm, −115 ppm, and −119 ppm. The crosslinked Si silanol species give rise to ²⁹Si signals in the Q³ region at −97 ppm, −99 ppm, and −101 ppm. Correlated ²⁷Al—²⁹Si signals in 2D ²⁷Al{²⁹Si} J-mediated spectra are assigned based on comparisons with previous 2D ²⁹Si{²⁹Si} and ²⁹Si{¹H}NMR analyses of calcined zeolite, analyses and ²⁹Si chemical shift values to the mean -T-O-T- bond angles and T-O bond lengths, and prior literature. Correlated ²⁷Al and ²⁹Si signals are resolved in the 2D ²⁷Al{²⁹Si} J-mediated HMQC spectra at ²⁹Si shifts of −107 ppm to −105 ppm, and −101 to −99 ppm. This correlation can also be calculated by correlating the Q⁴(1Al)²⁹Si chemical shift, δ, to the average -T-O-T- bond angles, θ′.

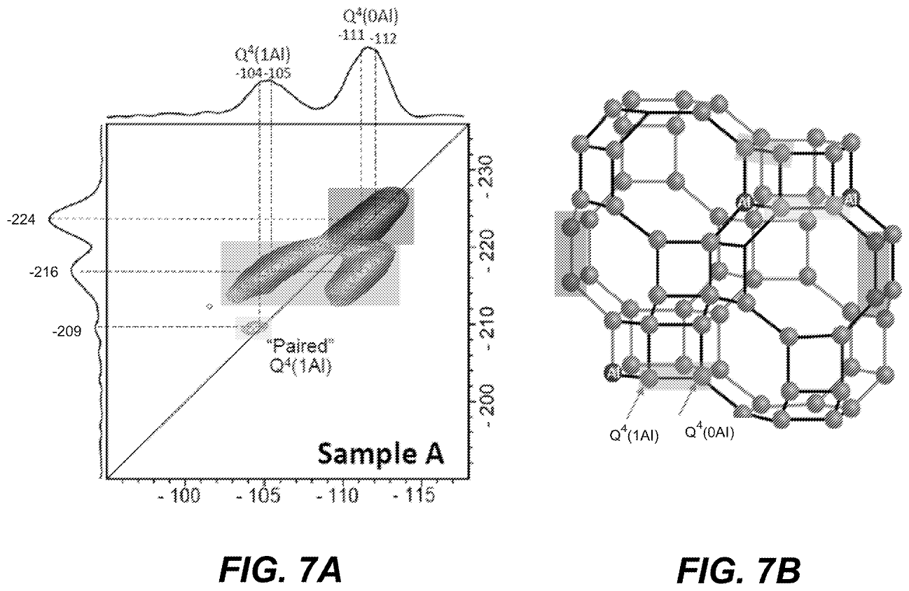

The method of characterizing covalent bond connectivities between J-coupled heteroatoms in a zeolite material, wherein the synthesis of the zeolite material comprises using trimethyladamantylammonium hydroxide (TMAdaOH) as the organic structure-directing agent (OSDA). The synthesis further comprises crystallizing a silicate solution and Na-FAU; and neutralizing the excess with H₂SO₄. An example of the correlation of the ²⁹Si—O—²⁹Si connectivity differences to a 2D NMR spectrum is shown in FIGS. 7(A) and 7(B).

The method of characterizing covalent bond connectivities between J-coupled nuclei of heteroatoms in a zeolite material, wherein the NMR spectrum is a 2D solid-state NMR spectrum.

The method of characterizing covalent bond connectivities between J-coupled nuclei of heteroatoms in a zeolite material, wherein the NMR spectrum is HQMC NMR spectrum.

The method of characterizing covalent bond connectivities between J-coupled nuclei of heteroatoms in a zeolite material comprising, wherein the zeolite material comprises a zeolite catalyst composition with paired aluminum atoms in the framework, wherein the paired aluminum atoms are separated as second- or third-nearest T-site neighbors in a zeolite structure.

The method of characterizing covalent bond connectivities between J-coupled nuclei of heteroatoms in a zeolite material comprising, where the zeolite catalyst is a chabazite zeolite catalyst.

The method of characterizing covalent bond connectivities between J-coupled nuclei of heteroatoms in a zeolite material comprising, where the chabazite zeolite catalyst is synthesized using Na-FAU.

The method of characterizing covalent bond connectivities between J-coupled nuclei of heteroatoms in a CHA zeolite material comprising, where the catalyst composition has a signature that ranges from −104 ppm to −108 ppm in the single quantum (SQ) dimension and −208 to −212 ppm in the double quantum (DQ) dimension when measured using 2D when measured using 2D ²⁹Si{²⁹Si} J-mediated NMR.

The method of characterizing covalent bond connectivities between J-coupled nuclei of heteroatoms in a CHA zeolite material comprising, where the catalyst composition yields a NMR spectral signature where the peak intensities are about 10% to 50% higher than for catalyst compositions where the paired aluminum atoms are not third-nearest neighbors (3NN).

The method of characterizing covalent bond connectivities between J-coupled nuclei of heteroatoms in a CHA zeolite material comprising, where the catalyst composition yields a NMR spectral signature ranging from −98 ppm to −100 ppm in the ²⁹Si dimension and 55 to 59 ppm in the ²⁷Al dimension when measured using 2D²⁷Al{²⁹Si} J-HMQC NMR.

### EMBODIMENTS

Without limitation, some embodiments of the disclosure include:
Embodiment 1. A zeolite catalyst with paired aluminum atoms, wherein the paired aluminum atoms are third-nearest neighbors (3NN) in a zeolite structure and wherein the zeolite catalyst has an aging durability, an improved catalytic activity, or a combination thereof.
Embodiment 2. The zeolite catalyst of embodiment 1, wherein the zeolite catalyst is a CHA zeolite catalyst.
Embodiment 3. The zeolite catalyst of embodiment 2, wherein the CHA zeolite catalyst is a copper-CHA catalyst.
Embodiment 4. The catalyst composition of embodiment 1, wherein the zeolite is a small pore zeolite.
Embodiment 5. The catalyst composition of embodiment 4, wherein the small pore zeolite is AEI.
Embodiment 6. The catalyst composition of embodiment 4, wherein the small pore zeolite is AFX.
Embodiment 7. The catalyst composition of embodiment 4, wherein the small pore zeolite is AFT.
Embodiment 8. The zeolite catalyst of embodiment 1, wherein the zeolite catalyst has a ²⁹Si NMR signature that ranges from −104 ppm to −108 ppm in the single quantum (SQ) dimension and −208 to −212 ppm in the double quantum (DQ) dimension when measured using 2D ²⁹Si{²⁹S}i J-mediated NMR.
Embodiment 9. The zeolite catalyst of embodiment 1, wherein the zeolite catalyst has an NMR signature ranging from −98 ppm to −100 ppm in the ²⁹Si dimension and 55 to 59-ppm in the ²⁷Al dimension when measured using 2D ²⁷Al{²⁹Si} J-HMQC NMR.
Embodiment 10. The zeolite catalyst of embodiment 1, wherein the aging durability is after 800° C. hydrothermal aging, the zeolite catalyst exhibits 10% higher NOₓ conversion relative to a zeolite that does not contain the 3NN sites.
Embodiment 11. The zeolite catalyst of embodiment 1, wherein the age durability is after 850° C. hydrothermal aging, the zeolite catalyst exhibits at least 50% NOₓ conversion.
Embodiment 12. The zeolite catalyst of embodiment 1, wherein the improved catalytic activity of the zeolite catalyst for methanol dimerization, with approximately 10% higher conversion relative to a zeolite that does not contain the 3NN sites.
Embodiment 13. The zeolite catalyst of embodiment 1, wherein the zeolite catalyst has a SiO₂/Al₂O₃ ratio (SAR) chosen from 8-40, 10-30, and 11-25.
Embodiment 14. The zeolite catalyst of embodiment 1, wherein the zeolite catalyst further comprises copper (Cu) with a Cu content corresponding to a Cu/Al ratio chosen from of 0.2 to 0.5, 0.25 to 0.45, and 0.3 to 0.4.
Embodiment 15. A catalyst article effective to abate nitrogen oxides (NOₓ) from a lean burn engine exhaust gas, the catalyst article comprising a substrate carrier having a selective catalytic reduction (SCR) catalyst according to embodiment 1.
Embodiment 16. The catalyst article of embodiment 15, wherein the substrate carrier is a honeycomb substrate, and optionally constructed of metal or ceramic.
Embodiment 17. The catalyst article of embodiment 15, wherein the honeycomb substrate carrier is a flow-through substrate or a wall flow filter.
Embodiment 18. An exhaust gas treatment system comprising:
a lean burn engine that produces an exhaust stream;
and
a catalyst article according to embodiment 15 positioned downstream from the lean burn engine and in fluid communication with the exhaust gas stream.
Embodiment 19. The exhaust gas treatment system of embodiment 18, further comprising one or more of the following:
a. a diesel oxidation catalyst (DOC) positioned upstream of the catalyst article;
b. a soot filter positioned upstream of the catalyst article; and
c. an ammonia oxidation catalyst (AMOX) positioned downstream of the catalyst article.
Embodiment 20. A process for preparing a selective catalytic reduction (SCR) catalyst comprising:
(a) preparing the catalyst based on any one of embodiments 1-14;
(b) applying the catalyst as a coating onto a ceramic or metallic honeycomb substrate monolith;
(d) drying the coated monolith;
(e) calcining the coated monolith at a temperature ranging from 400° C. to 800° C.
Embodiment 21. The zeolite catalyst of embodiment 1, wherein the aluminum source is Na-FAU.
Embodiment 22. The zeolite catalyst of embodiment 1, wherein the aluminum source is aluminum isopropoxide.
Embodiment 23. The zeolite catalyst of embodiment 1, wherein the aluminum source is H-FAU.
Embodiment 24. The zeolite catalyst of embodiment 1, wherein the silicon source is sodium silicate.
Embodiment 25. The zeolite catalyst of embodiment 1, wherein the silicon source is colloidal silica.
Embodiment 26. The zeolite catalyst of embodiment 1, wherein the silicon source is H-FAU.
Embodiment 27. The zeolite catalyst of embodiment 1, wherein the Na/Si ratio is 0.818.
Embodiment 28. The zeolite catalyst of embodiment 1, wherein the Na/Si ratio is 0.785.
Embodiment 29. The zeolite catalyst of embodiment 1, wherein the Na/Si ratio is 0.194.
Embodiment 30. The zeolite catalyst of embodiment 1, wherein the OH/Si ratio is 0.506.
Embodiment 31. The zeolite catalyst of embodiment 1, wherein the OH/Si ratio is 0.675.
Embodiment 31. The zeolite catalyst of embodiment 1, wherein the OH/Si ratio is 0.418.

Claims or descriptions that include “or” or “and/or” between at least one members of a group are considered satisfied if one, more than one, or all the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given (such as, e.g., from [X] to [Y]), endpoints (such as, e.g., [X] and [Y] in the phrase “from [X] to [Y]”) are included unless otherwise indicated. Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

### EXAMPLES

The following examples are intended to be illustrative and are not meant in any way to limit the scope of the disclosure.

### Example 1: Measuring the Catalytic Properties of Samples A, B, C, D, and G

Sample A is a CHA zeolite and was synthesized where trimethyladamantylammonium hydroxide (TMAdaOH) was used as the organic structure directing agent (OSDA) for CHA. The crystallization of Sample A utilized a sodium silicate solution (SiO₂/Na₂O=2.6, 37% solids content) and Na-FAU (SiO₂/Al₂O_{3=5.1}) as Si and Al sources, respectively. The desired OH/Si ratio was obtained by neutralizing the excess OH with H₂SO₄. a 1:1 ratio between Na⁺ and OH was assumed for the sodium silicate solution to calculate OH/SiO₂ ratio.

Sample B, also a CHA zeolite, was synthesized, and trimethyladamantylammonium hydroxide (TMAdaOH) was used as the organic structure directing agent (OSDA) for CHA. For the crystallization of Sample B, sodium hydroxide (NaOH) was used as the mineralizing agent and the sole source of Na⁺ in the gel, and aluminum isopropoxide and colloidal silica (40 wt. % SiO₂) acted as Si and Al sources, respectively.

After crystallization, Sample A and Sample B were isolated by filtration, dried and calcined at 540° C. for 6 h to yield the Na⁺ form.

After calcination, single or multiple NH₄⁺ exchanges were performed until Na₂O content reached <500 ppm. Further calcination of the NH₄⁺ form at 450° C. for 6 h yielded the H⁺ form.

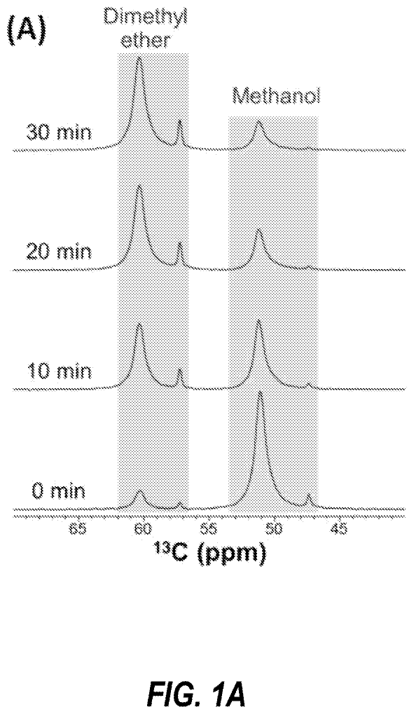

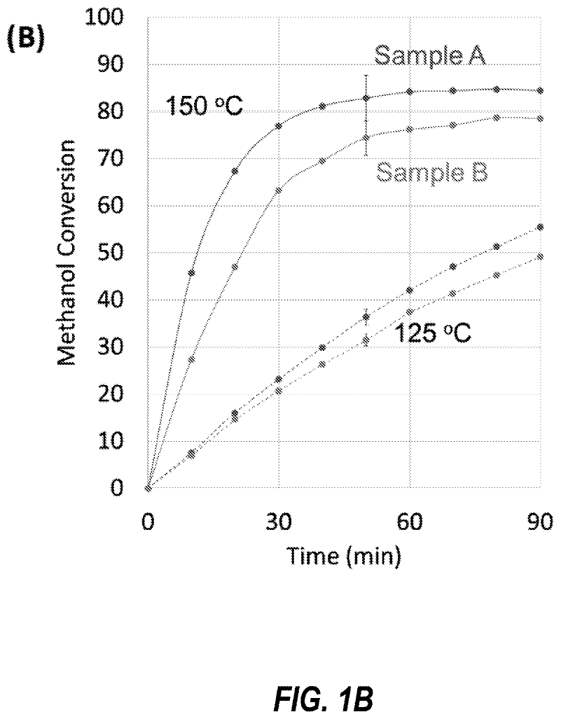

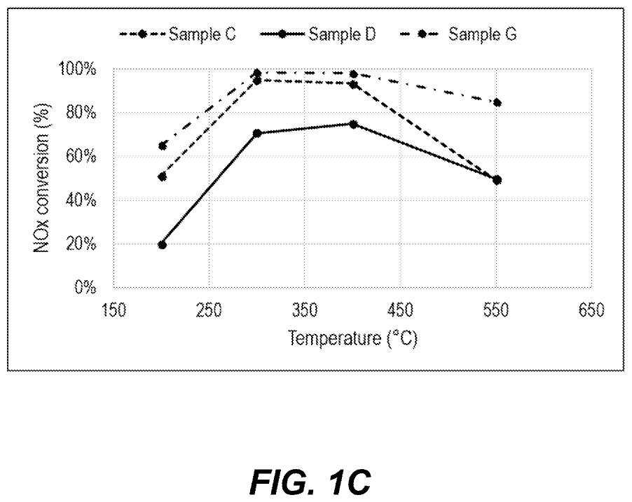

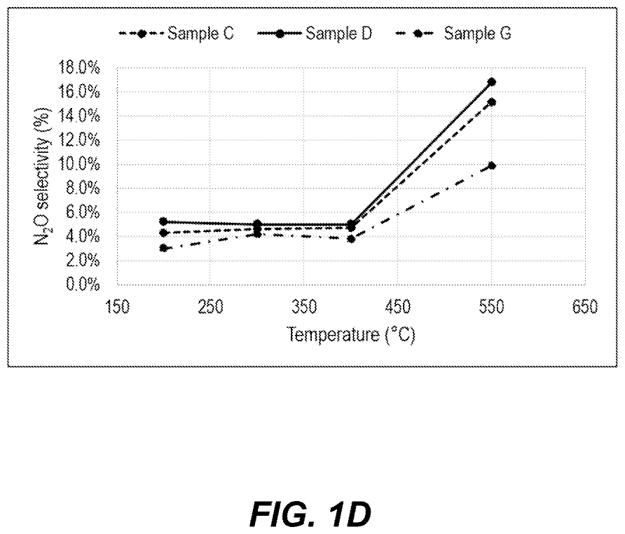

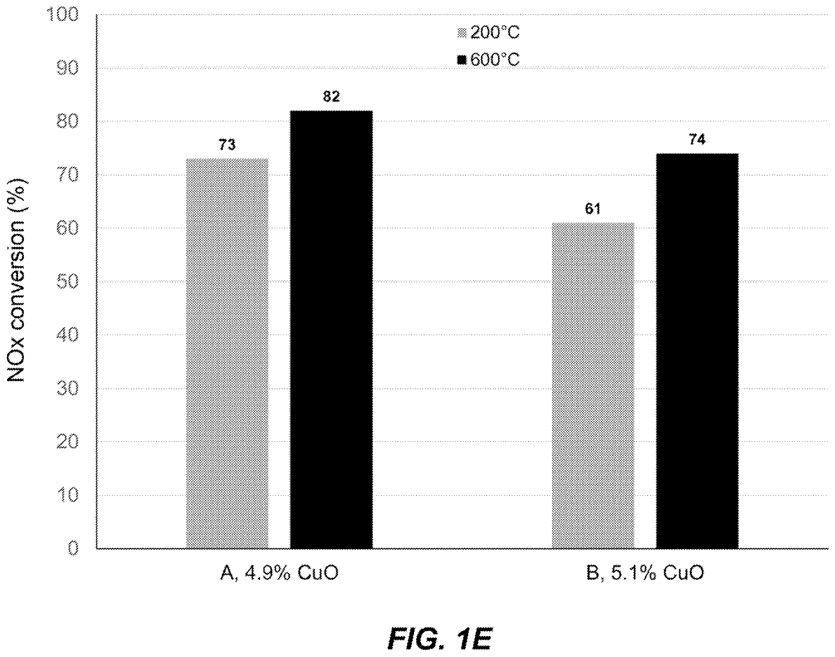

NMR is used to determine the conversion of methanol to dimethyl ether over time. In some embodiments, the conversion of methanol to dimethyl ether at 125° C. and 150° C. in a batch reactor using in situ ¹³C NMR was used to measure the catalytic properties of the dehydrated H⁺-forms of Sample A and Sample B. As shown in FIG. 1A, representative time-resolved ¹³C direct-excitation NMR spectra show ¹³C signals ranging from 47 ppm to 54 ppm, which correspond to adsorbed methanol species in different local environments. The spectra were acquired at 11.7 T and 5 kHz MAS. FIG. 1A also shows NMR spectra also where ¹³C signals range from 56 ppm to 64 ppm, which correspond to dimethyl ether species.

The conversion of methanol as a function of time is shown in FIG. 1B for reactions over both samples at 125° C. and 150° C. To determine the conversions of methanol over time at different conditions, the intensities of the spectra for adsorbed methanol and dimethyl ether species were each integrated. At both temperatures, the rate of methanol conversion over Sample A was significantly higher than the rate of methanol conversion over Sample B.

Samples C, D, and G are CHA zeolites and were synthesized using trimethyladamantylammonium hydroxide (TMAdaOH) as the organic structure-directing agent (OSDA) for CHA. The sources for Si and Al for Sample C were sodium silicate, and Na-FAU, respectively. The component mole ratios for Sample C are as follows: Na/Si=0.785, R/Si=0.03, OH/Si=0.625, and H₂O/Si=33.2. Crystallization for Sample C occurred at 140° C. for 72 h.

The sources for Si and Al for Sample D were colloidal silica, and aluminum isopropoxide, respectively. The component mole ratios for Sample D are as follows: Na/Si=0.207, R/Si=0.108, OH/Si=0.315, and H₂O/Si=23.6. Crystallization for Sample D occurred at 160° C. for 45 h.

The sources for Si and Al for Sample G was H-FAU. The component mole ratios for Sample G are as follows: Na/Si=0.194, K/SI=0.124, R/Si=0.100, OH/Si=0.418, and H₂O/Si=22.2. Crystallization for Sample G occurred at 150° C. for 24 h.

Samples C, D, and G were calcined at 540° C. for 6 h under a stream of flowing dry air. After the first calcination step, unlike Samples A and B, samples C, D, and G were subjected to two ammonium exchange steps. The two ammonium exchange steps were then followed by a second calcination step at 450° C. for 6 h under a stream of flowing dry air. Cu ions were introduced to the H⁺ form zeolites to attain the target CuO loading of 6.8-7.2 wt. %. Catalytic coatings containing Cu-CHA, zirconium oxide and pseudoboehmite binder were disposed via a washcoat process on the samples. The coated monoliths were dried at 110-150° C. and calcined at about 550° C. for 1 h. The coating process provided a catalyst loading of 2.2 g/in³ of which 5% is zirconium oxide and 5% is aluminum oxide binder. The coated monoliths were hydrothermally aged in the presence of 10% H₂O/air at 800° C. for 16 h.

NOₓ conversions for the 800° C./16 h aged monoliths (Samples C, D, and G) were measured in a laboratory reactor at a gas hourly volume-based space velocity of 80,000 h⁻¹ under pseudo-steady-state conditions in a gas mixture of 500 ppm NO, 525 ppm NH₃, 10% O₂, 10% H₂O, balance N₂ in a temperature ramp of 5° C./min from 200° C. to 550° C. The NOₓ conversion and the N₂O selectivity data in FIGS. 1C and 1D, respectively, demonstrate that these performance characteristics of interest directly depend on the amount of 3NN paired Al sites in the three samples. NOₓ conversion for Samples A and B was previously determined in U.S. Pat. No. 11,267,717 (as samples F and C in FIG. 5) and is shown in FIG. 1E.

Sample G, which shows significantly higher 3NN paired Al sites than both Sample C and Sample D, has the highest NOₓ conversion across the entire temperature range and the lowest N₂O selectivity of the three samples across the entire temperature range. Sample D, which shows the fewest third-nearest-neighbor Al site configurations of the three samples, has the lowest NOₓ conversion of the three materials except at 550° C. and the highest N₂O selectivity across the entire temperature range.

Samples A, B, C, D, and G can be divided into two main groups. Samples A was synthesized with silicate solution and Na-FAU as the Si and Al sources, respectively, while Sample B was synthesized with colloidal silica and aluminum isopropoxide. Samples A and B were both ion-exchanged with ammonium only once. Samples C and D had the same starting materials as Samples A and B, respectively. Sample G was synthesized with H-FAU as the silicon and aluminum source. Samples C, D, and G were ion-exchanged with ammonium twice. Among Samples A, B, Sample A showed better performance as demonstrated in methanol conversion testing in FIGS. 1A and 1B. Among Samples C, D, and G, Samples C, and G showed higher 3NN paired Al sites and better performance in the NOₓ conversion and N₂O selectivity tests as shown in FIGS. 1C and 1D. FIGS. 1A-1E show that among samples A, B, C, D, and G, Samples A, C, and G have the catalytic performance and unique NMR features according to the present disclosure. The Table below (Table 1) show data for Samples, A, C, and G, their starting materials, and their Na/Si and OH/Si ratios.

TABLE 1
Synthesis Information for Samples A, B, C, D, and G

| | | Primary Si | | | |
|---|---|---|---|---|---|
| Sample | Al source | source | Na/Si | K/Si | OH/Si |
| Sample A | Na-FAU | Sodium silicate | 0.818 | 0 | 0.506 |
| Sample B | Aluminium | Colloidal silica | 0.128 | | 0.198 |
| | isopropoxide | | | | |
| Sample C | Na-FAU | Sodium silicate | 0.785 | 0 | 0.675 |
| Sample D | Aluminium | Colloidal silica | 0.207 | 0 | 0.315 |
| | isopropoxicie | | | | |
| Sample G | H-FAU | H-FAU | 0.194 | 0.124 | 0.418 |
| | (SAR = 12) | (SAR = 12) | | | |

### Example 2: Measuring Reaction Properties Via Solid State NMR

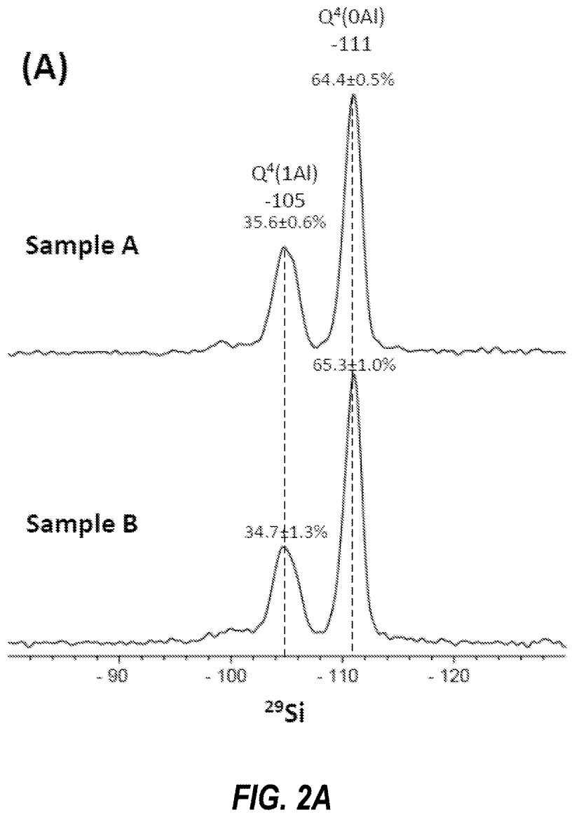

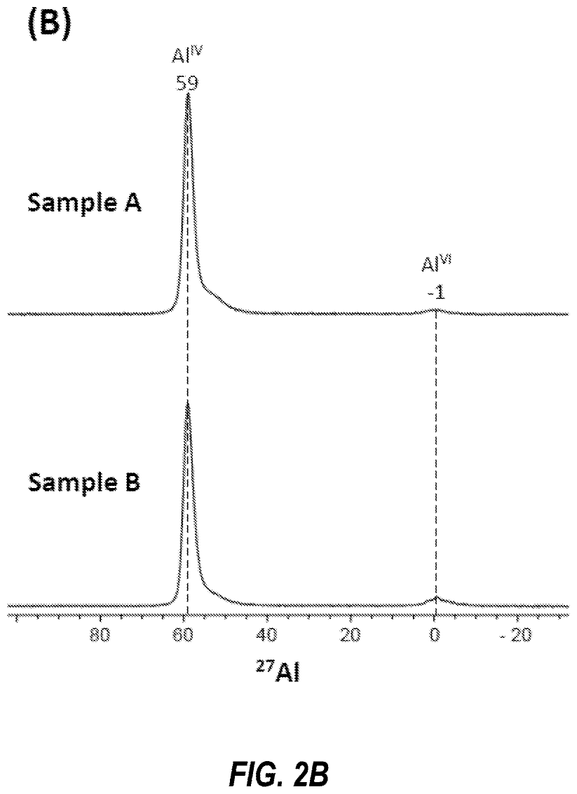

Solid-state NMR is sensitive to the local chemical environments of ²⁷Al and ²⁹Si atoms in aluminosilicate zeolites and may be used to determine reaction properties. In some embodiments, FIG. 2A shows the one-dimensional (1 D) ²⁹Si direct-excitation NMR spectra of the H⁺-forms of Sample A and Sample B with approximately the same SiO₂/Al₂O₃ ratio (SAR). The spectra were acquired at 18.8 T, 20 kHz MAS and 298 K. Each sample exhibits two strong signals which correspond to Q⁻(0Al) and Q⁴(1Al) moieties, at −111 ppm and −105 ppm. The relative intensities of the signals for Q⁴(0Al) and Q₄(1Al) are similar for both Sample A and Sample B, which corresponds to the Sample A and Sample B having similar SAR values.

FIG. 2B shows 1D ²⁷Al direct-excitation NMR spectra of the H⁺-forms of Sample A and Sample B. The prominent ²⁷Al signal in both spectra at 59 ppm corresponds to four-coordinate Al atoms. This is consistent with their incorporation within the aluminosilicate zeolite framework, while the weak signal near −1 ppm in each spectrum corresponds to extra-framework six-coordinate Al atoms. No significant differences were observed in these 1 D ²⁷Al NMR spectra of the two samples.

### Example 3: Measuring Reaction Properties Via Multidimensional NMR Techniques

Multidimensional NMR was used to provide more detailed insights into the local chemical environments of a material by probing nanoscale through-bond and through-space interactions between NMR-active nuclei. For example, two-dimensional (2D) J-mediated ²⁹Si{²⁹Si} single-quantum (SQ)-double-quantum (DQ) NMR correlation spectra can be used to detect ²⁹Si—O—²⁹Si connectivities in aluminosilicate materials.

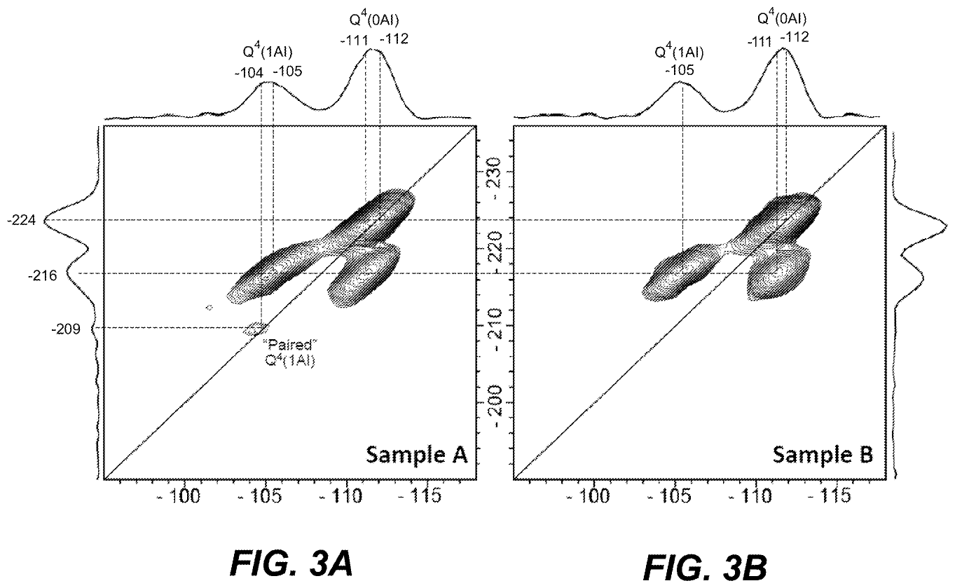

In some embodiment, FIGS. 3A and 3B shows the 2D ²⁹Si{²⁹Si} J-mediated SQ-DQ NMR correlation spectra of the H⁺-forms of Sample A and Sample B. In these spectra, correlated signal intensities may manifest covalently connected ²⁹Si atoms, including those via covalently-bonded bridging oxygen atoms in²⁹Si—O—²⁹Si moieties. Signals along the diagonal line correspond to ²⁹Si—O—²⁹Si moieties in the same local environments, while pairs of correlated signals with the same double-quantum shifts (vertical dimension) that are equidistant on opposite sides of the diagonal line correspond to ²⁹Si—O—²⁹Si moieties involving two different local ²⁹Si environments. For example, the ²⁹Si signal at −112 ppm in the single-quantum (horizontal) dimension and −224 ppm in the double-quantum (vertical) dimension in each spectrum corresponds to covalently bonded Q₄(0Al) moieties in siliceous regions of each material. By comparison, the correlated signals at −216 ppm in the SQ (vertical) dimension and at −105 ppm and −111 ppm in the DQ (horizontal) dimension in the spectrum obtained from Sample A correspond to covalently bonded Q₄(0Al) and Q₄(1Al) moieties. Notably, the correlated signal near the diagonal at −209 ppm in the vertical dimension appear in the spectrum obtained from Sample A, but are not detected in the spectrum obtained from Sample B. These signals correspond to covalently bonded Q₄(1Al) moieties that are present in the framework Al in an Al—O—(Si—O)₂—Al configuration.

### Example 4: Measuring Covalent Bond Connectivities Via Solid State/Heteronuclear Multiple Quantum Coherence (HQMC) NMR

Similarly, solid-state 2D NMR techniques can also be used to detect covalent bond connectivities between J-coupled heteroatoms, such as ²⁷Al and ²⁹Si in aluminosilicate materials. In some embodiments, 2D²⁷Al{²⁹Si} J-mediated heteronuclear multiple quantum coherence (HMQC) NMR spectra may yield direct information on framework ²⁷Al atoms in aluminosilicate zeolites and can distinguish different types and distributions of ²⁷Al—O—²⁹Si moieties.

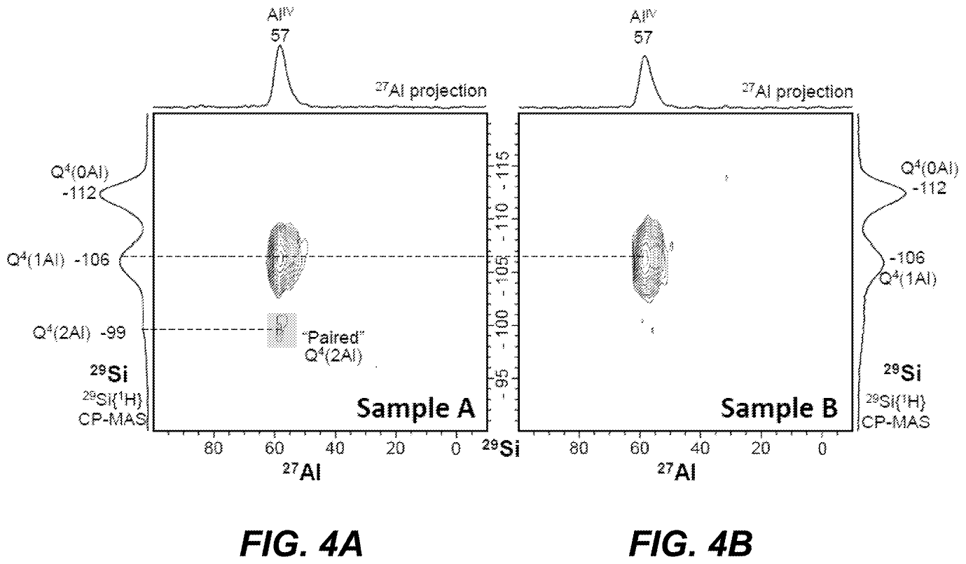

In one embodiment, FIGS. 4A and 4B shows the 2D²⁷Al{²⁹Si} J-HMQC NMR spectra obtained for the H⁺-forms of Sample A and Sample B. Spectra was acquired at 9.4 T, 8 kHz MAS, and 100 K. These spectra reveal a ²⁷Al signal at 57 ppm corresponding to four-coordinate framework Al atoms correlated with framework ²⁹Si atoms. In the spectra obtained from both samples, this ²⁷Al signal is correlated with a ²⁹Si signal at −106 ppm corresponding to Q₄(1Al) moieties. The spectra for Sample A show additional correlated signal intensity is observed between the ²⁷Al signal at 57 ppm from framework Al atoms with a signal at −99 ppm in the ²⁹Si dimension that is assigned to Q⁴(2Al) species. This signal is not observed in the spectrum obtained from Sample B, indicating that such moieties are not present to a significant extent. This provides further evidence that Sample A contains more locally paired Al atoms that are separated by one or two O—Si—O moieties than Sample B. The different distributions of framework Al atoms, including the types and numbers of proximate framework Al atoms, in Samples A and B are thought to account for their different adsorption and reaction properties.

### Example 5

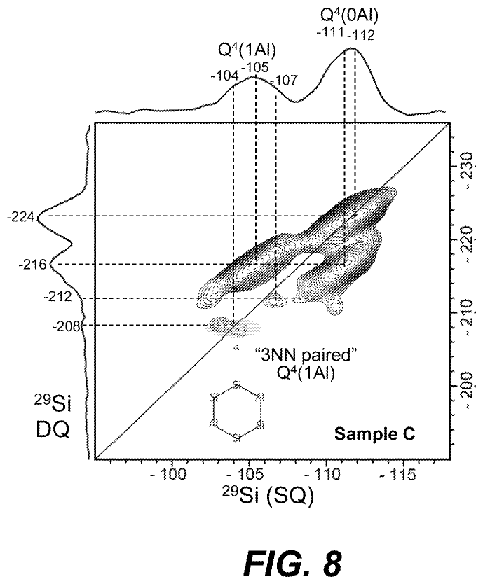

To further demonstrate the spectroscopic signature of third-nearest-neighbor (3NN) paired Al, the 2D ²⁹Si{²⁹Si} J-mediated solid-state single-quantum-double-quantum NMR correlation spectrum of a third sample, termed Sample C, is shown in FIG. 8. J couplings occur between NMR-active nuclei in atoms that are covalently bonded or through other covalently bonded atoms. Sample C has a SAR of 11, in contrast to the SAR of ˜19 for Samples A and B; Sample C synthesis is similar to that of Sample A. The 2D ²⁹Si{²⁹Si} J-mediated SQ-DQ NMR correlation spectrum in FIG. 8 resolves signals from J-coupled pairs of ²⁹Si nuclei based on their isotropic ²⁹Si chemical shifts. It was obtained under the same conditions as those for Samples A and B. The correlated signal at −112 ppm in the single-quantum (SQ) dimension and −224 ppm in the double-quantum (DQ) dimension corresponds to pairs of Q⁴(0Al) species that are covalently bonded through a bridging oxygen atom (e.g., ²⁹Si—O—²⁹Si), while the signals at −216 ppm in the double-quantum dimension and at −105 and −111 ppm in the single-quantum dimension correspond to Q⁴(1Al) and Q⁴(0Al) species that are similarly bonded covalently through a bridging oxygen atom. Most importantly, correlated (SQ,DQ) intensity at (−104 ppm, −208 ppm) corresponds to paired Q⁴(1Al) species, which provides direct evidence of third-nearest-neighbor aluminum configurations.

### Example 6

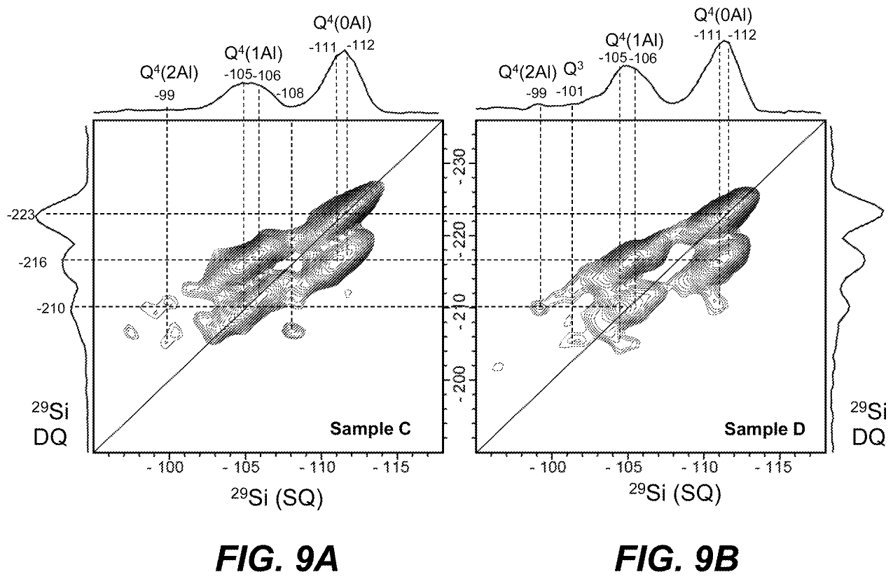

In addition to probing covalent bond connectivity by using J couplings, solid-state NMR can probe more distant (ca. 1 nm) proximities of nuclei by exploiting through-space ²⁹Si—²⁹Si dipole-dipole couplings that are used to resolve signals from dipolar-coupled pairs of ²⁹Si nuclei based on their isotropic ²⁹Si chemical shifts. FIGS. 9(A) and 9(B) shows 2D ²⁹Si{²⁹Si} dipolar-mediated NMR correlation spectra for two samples with SAR of 11, Sample C and Sample D, respectively, which reveal different intensity distributions that manifest different Al distributions within the zeolite framework. Sample D synthesis is similar to that of Sample B. These measurements were made under the same conditions as the 2D ²⁹Si{²⁹Si} J-mediated correlation spectrum above. Regions of correlated signal intensity correspond to proximate pairs of ²⁹Si nuclei (and their associated atoms) separated by ca. 1 nm. The signal at −112 ppm in the single-quantum dimension and ca. −223 ppm in the double-quantum dimension corresponds to proximate Q⁴(0Al) species. The signals at −105 ppm and ca. −111 ppm in the single-quantum dimension are correlated with the signal at −216 ppm in the double-quantum dimension and correspond to proximate Q⁴(0Al) and Q⁴(1Al) species. The signal centered at −105 ppm in the single-quantum dimension and −210 ppm in the double-quantum dimension corresponds to proximate pairs of Q⁴(1Al) species. While both Samples C and D exhibit 2D ²⁹Si{²⁹Si}intensity from proximate Q⁴(1Al) framework moieties, interestingly, their intensity distributions are different. For example, along the double diagonal lines of the two spectra, the distribution of 2D ²⁹Si{²⁹Si}intensity is narrower and more elongated for Sample C, compared to Sample D which appears to be more inhomogeneously broadened.

This indicates that the framework Al environments in Sample C are locally more uniform than in Sample D.

### Example 7

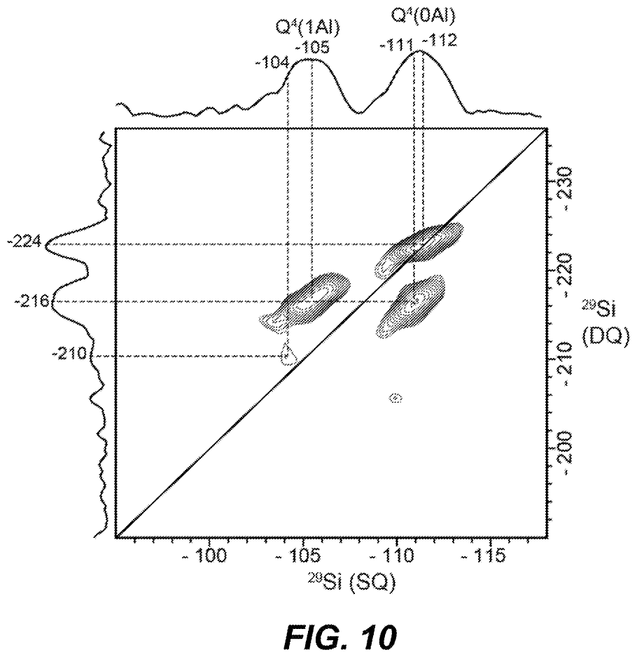

To understand the differences in the spectroscopic signature of third-nearest-neighbor (3NN)-type paired Al species in chabazite materials with different preparation methods, the 2D ²⁹Si{²⁹Si} J-mediated SQ-DQ solid-state NMR correlation spectrum of Sample D is shown in FIG. 10. Sample D has a silicon-to-aluminum ratio (SAR) of 11, the same as Sample C. The spectrum shown in FIG. 10 resolves signals from pairs of J-coupled ²⁹Si nuclei, resulting in signals from pairs of ²⁹Si atoms that are covalently bonded through a bridging oxygen atom (²⁹Si—O—²⁹Si). This spectrum was obtained under the same conditions as Samples A, B, C, D, and G. The correlated single-quantum (SQ) ²⁹Si signal at −112 ppm and double-quantum (DQ) ²⁹Si signal at −224 ppm correspond to pairs of Q⁴(0Al) ²⁹Si species in locally siliceous regions that are covalently bonded through a bridging oxygen atom (²⁹Si—O—²⁹Si). The DQ ²⁹Si signal at ˜216 correlated with ²⁹Si signals at −111 and −105 ppm in the SQ dimension corresponds to through-bond pairs of J-coupled Q⁴(0Al) and Q⁴(1Al) ²⁹Si moieties. The DQ ²⁹Si signal at −210 ppm correlated to a SQ ²⁹Si signal at −104 ppm corresponds to Q⁴(1Al)—O-Q⁴(1Al) pairs of J-coupled ²⁹Si nuclei, which provide evidence of 3NN pairs of Al atoms (i.e., —²⁷Al—O—²⁹Si—O—²⁹Si—O—²⁷Al— m moieties) in the zeolite framework. Notably, this signal appears less intense than the same signal for Sample C in Example 5, suggesting fewer third-nearest-neighbor tetrahedral-site (T-site) configurations are present in Sample D than in Sample C.

### Example 8

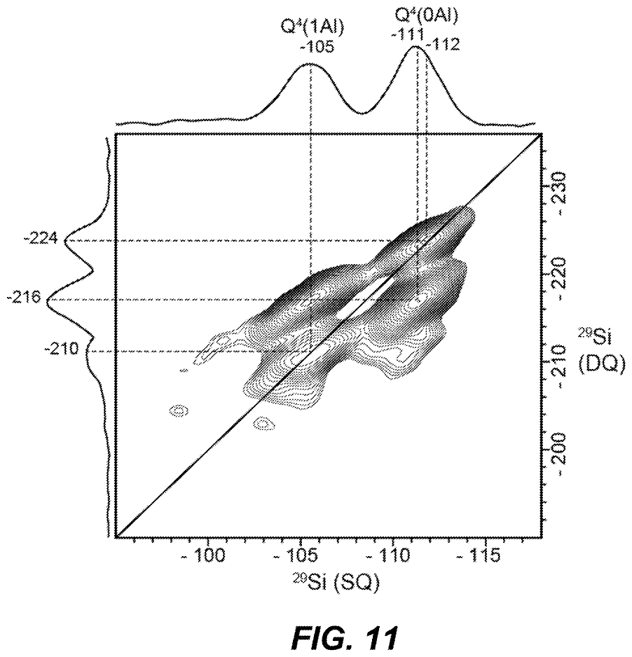

As a further comparison, a third low SAR chabazite material, Sample G, was prepared and analyzed. Sample G has a SAR of ˜11, similar to Samples C and D. FIG. 11 shows the 2D ²⁹Si{²⁹Si} J-mediated SQ-DQ solid-state NMR correlation spectrum of Sample G. This spectrum was acquired under the same conditions as similar spectra for Samples A, B, C, D, and G. The 2D ²⁹Si{²⁹Si} J-mediated SQ-DQ solid-state NMR correlation spectrum shows correlated signals resulting from J-coupled pairs of ²⁹Si nuclei, which correspond to ²⁹Si—O—²⁹Si covalent-bond linkages. FIG. 11 shows correlated intensity between the single-quantum (SQ) ²⁹Si signal at −112 ppm and the double-quantum (DQ) ²⁹Si signal at −224 ppm, which corresponds to covalently linked pairs of Q⁴(0Al) species. A DQ ²⁹Si signal at −216 ppm that is correlated with SQ ²⁹Si signals at −105 and −111 ppm corresponds to Q⁴(0Al)—O-Q⁴(1Al) linkages, as for the other samples. Most notably, a DQ ²⁹Si signal at −210 ppm is correlated with a SQ ²⁹Si signal at −105 ppm, which corresponds to pairs of covalently linked Q⁴(1Al)—O-Q⁴(1Al) framework moieties with third-nearest-neighbor paired aluminum configurations. It is noteworthy that this correlated ²⁹Si{²⁹Si}signal is much more intense than intensity observed in this spectral region for Samples A, B, C, and D (see above), manifesting a greater number of 3NN paired-Al configurations in Sample G than these other samples. In addition, the larger width of the correlated intensity near (−210 ppm, −105 ppm) in FIG. 11 manifests a broader distribution of different 3NN paired-Al configurations present in Sample G compared to the other samples.

1. A zeolite catalyst with paired aluminum atoms, wherein the paired aluminum atoms are third-nearest neighbors (3NN) in a zeolite structure and wherein the zeolite catalyst has an aging durability, an improved catalytic activity, or a combination thereof.

2. The zeolite catalyst of claim 1, wherein the zeolite catalyst is a CHA zeolite catalyst.

3. The zeolite catalyst of claim 2, wherein the CHA zeolite catalyst is a copper-CHA catalyst.

4. The catalyst composition of claim 1, wherein the zeolite is a small pore zeolite.

5. The catalyst composition of claim 4, wherein the small pore zeolite is AEI.

6. The catalyst composition of claim 4, wherein the small pore zeolite is AFX.

7. The catalyst composition of claim 4, wherein the small pore zeolite is AFT.

8. The zeolite catalyst of claim 1, wherein the zeolite catalyst has a ²⁹Si NMR signature that ranges from −104 ppm to −108 ppm in the single-quantum (SQ) dimension and −208 to −212 ppm in the double-quantum (DQ) dimension when measured using 2D ²⁹Si{²⁹Si} J-mediated SQ-DQ NMR.

9. The zeolite catalyst of claim 1, wherein the zeolite catalyst has an NMR signature ranging from −98 ppm to −100 ppm in the ²⁹Si dimension and 55 to 60 ppm in the ²⁷AI dimension when measured using 2D²⁷AI{²⁹Si} J-HMQC NMR.

10. The zeolite catalyst of claim 1, wherein the aging durability is after 800° C. hydrothermal aging, the zeolite catalyst exhibits 10% higher NOx conversion relative to a zeolite that does not contain the 3NN sites.

11. The zeolite catalyst of claim 1, wherein the age durability is after 850° C. hydrothermal aging, the zeolite catalyst exhibits at least 50% NOx conversion.

12. The zeolite catalyst of claim 1, wherein the improved catalytic activity of the zeolite catalyst for methanol dimerization, with approximately 10% higher conversion relative to a zeolite that does not contain the 3NN sites.

13. The zeolite catalyst of claim 1, wherein the zeolite catalyst has a SiO₂/Al₂O₃ ratio (SAR) chosen from 8-40, 10-30, and 11-25.

14. The zeolite catalyst of claim 1, wherein the zeolite catalyst further comprises copper (Cu) with a Cu content corresponding to a Cu/AI ratio chosen from of 0.2 to 0.5, 0.25 to 0.45, and 0.3 to 0.4.

15. A catalyst article effective to abate nitrogen oxides (NOₓ) from a lean burn engine exhaust gas, the catalyst article comprising a substrate carrier having a selective catalytic reduction (SCR) catalyst according to claim 1.

16. The catalyst article of claim 15, wherein the substrate carrier is a honeycomb substrate, and optionally constructed of metal or ceramic.

17. The catalyst article of claim 15, wherein the honeycomb substrate carrier is a flow-through substrate or a wall flow filter.

18. An exhaust gas treatment system comprising:
a lean burn engine that produces an exhaust stream; and,
a catalyst article according to claim 15 positioned downstream from the lean burn engine and in fluid communication with the exhaust gas stream.

19. The exhaust gas treatment system of claim 18, further comprising one or more of the following:
a. a diesel oxidation catalyst (DOC) positioned upstream of the catalyst article;
b. a soot filter positioned upstream of the catalyst article; and,
c. an ammonia oxidation catalyst (AMOX) positioned downstream of the catalyst article.

20. A process for preparing a selective catalytic reduction (SCR) catalyst comprising:
(a) preparing the catalyst based on claim 1;
(b) applying the catalyst as a coating onto a ceramic or metallic honeycomb substrate monolith;
(d) drying the coated monolith; and,
(e) calcining the coated monolith at a temperature ranging from 400° C. to 800° C.
